(19) United States
(12) Patent Application Publication
(10) Pub. No.: US 2004/0084479 A1
(43) Pub. Date: May 6, 2004

(54) Valve

(76) Inventors: Brett C. Domoy, Brewster, NY (US); Gary Albaum, Croton, NY (US)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(21) Appl. No.: 10/287,451

(22) Filed: Nov. 4, 2002

(51) Int. Cl. B67D 5/52

(52) U.S. Cl. 222/136

(57) ABSTRACT

A valve system adapted for mixing and dispensing separately stored substances is provided. The valve has at least a two-way valve aspect and a one-way valve aspect in selective communication with two or more inner chambers housed in an outer housing. The outer housing preferably stores a propellant that creates pressure in the inner chambers for mixing and dispensing of the substances contained therein.

### BACKGROUND OF THE INVENTION

1. Field of the Invention

The present invention relates to valves for aerosol containers. More particularly, the present invention relates to valves for pressurized ejection of two or more substances from two or more chambers.

2. Description of the Prior Art

Pressurized systems are widely used for dispensing a variety of consumer and industrial products. These systems, referred to as “aerosols,” typically include three components: (1) a product to be dispensed, (2) a propellant, and (3) a pressurized container. The container is typically cylindrical and is capable of withstanding moderate pressures. In operation, a push button or other actuator opens a valve, allowing the product to be expelled from an opening or nozzle. The propellant, which is typically a gas under ambient conditions, is expelled from the container and mixed with the dispensed product. These conventional aerosol devices suffer from the drawbacks of limiting the dispensed product to one substance, i.e., a single dispensed product, and require mixing of the dispensed product with the propellant.

In U.S. Pat. No. 4,469,252, an aerosol container having dual chambers is disclosed. The aerosol container has an outer container and an inner container housed therein. The outer and inner containers are coupled through dispensing valves and dispensing tubes. The inner container contains component B and a propellant, and the outer container contains component A. Due to the higher pressure in the inner container, component B and the propellant are propelled through the dispensing tube and dispensing valve and into the pressureless outer container where it mixes with component A. The mixture is then dispensed as a result of the introduction of the propellant into the outer container. While this device allows for two products to be mixed and dispensed, it suffers from the drawback of requiring mixture of component B with the propellant.

### SUMMARY OF THE INVENTION

It is an object of the present invention to provide a valve system with an improved design.

It is another object of the present invention to provide such a valve system that allows for pressurized ejection of two or more substances from two or more chambers.

It is a further object of the present invention to provide such a valve system that allows for pressurized ejection of substances without mixing with propellant.

It is yet a further object of the present invention to provide such a valve system that allows for pressurized ejection of substances at any orientation of the container.

The above objects and advantages of the present invention are achieved by a valve system adapted for mixing and ejecting into the atmosphere two or more substances separately stored under pressure. The valve system has a first source for containing a first substance and a second source for containing a second substance with the second source in fluid isolation from the first source. The valve system also has an actuator, a mixing chamber in communication with the actuator and a valve operatively connected to the actuator. The valve allows fluid communication between the second source and the mixing chamber, selective fluid communication between the mixing chamber and the first source, and selective fluid communication between the mixing chamber and the atmosphere. Actuation of the actuator (i) allows the first substance and the second substance to flow into the mixing chamber, mix in the mixing chamber and be ejected from the mixing chamber to the atmosphere, or (ii) allows the second substance to be filled into the second source.

The valve can have a first orifice and a first gasket with the first orifice selectively sealed by the first gasket. Actuation of the actuator can allow the first orifice and the first gasket to unseal causing the first substance to flow into the mixing chamber or allows the first orifice and the first gasket to remain sealed when the second substance is filled into the second source. The first orifice can be positioned along a bottom portion of the mixing chamber. The first orifice can be two orifices. The valve can also have a second orifice and a second gasket with the second orifice selectively sealed by the second gasket, and the actuator causing the second orifice and the second gasket to unseal when actuated.

The actuator can be a slidable stem having a side and the stem can be biased in a non-actuated position. The second orifice can be positioned along the side with the second gasket surrounding at least a portion of the stem, and actuation of the actuator causing the stem to slide below the second gasket. The mixing chamber can be substantially cylindrical. The valve can be co-injection molded with the mixing chamber.

The present invention also includes a container adapted for mixing and ejecting into the atmosphere two or more substances separately stored under pressure. The container has a propellant chamber having a propellant, a first chamber isolated from the propellant chamber and having a first substance, and a second chamber isolated from the propellant chamber and the first chamber, and having a second substance. The container also has a valve system comprising an actuator, a mixing chamber in communication with the actuator, and a valve operatively connected to the actuator. The valve is in selective fluid communication with the mixing chamber and the first chamber, and in selective fluid communication with atmosphere, and the mixing chamber and the second chamber. Actuation of the actuator (i) allows the first substance and the second substance to flow into the mixing chamber, mix in the mixing chamber and be ejected from the mixing chamber to the atmosphere or (ii) allows the second substance to be filled into the second chamber.

The propellant can pressurize the first and second chambers. The valve can have a first orifice and a first gasket, and the first orifice can be selectively sealed by the first gasket. The actuation of the actuator can allow the first orifice and the first gasket to unseal causing the first substance to flow into the mixing chamber or can allow the first orifice and the first gasket to remain sealed when the second substance is filled into the second chamber. The first orifice can be positioned along a bottom portion of the mixing chamber. The first orifice can be two orifices. The valve can also have a second orifice and a second gasket with the second orifice selectively sealed by the second gasket, and the actuator causing the second orifice and the second gasket to unseal when actuated.

The actuator can be a slidable stem having a side and the stem can be biased in a non-actuated position. The second orifice can be positioned along the side with the second gasket surrounding the stem, and actuation of the actuator causing the stem to slide below the second gasket. The valve can be co-injected molded with the mixing chamber. The mixing chamber can be substantially cylindrical.

Other and further objects, advantages and features of the present invention will be understood by reference to the following.

### BRIEF DESCRIPTION OF THE DRAWINGS

FIG. 1 is a schematic diagram of the container and valve system of the present invention;

FIG. 2 is a top view of the container and valve system of FIG. 1;

FIG. 3 is a perspective view of the valve housing and flange of the valve system of FIG. 1;

FIG. 4 is a cross-sectional view of the valve system and a portion of the container of FIG. 1 taken along line 44 of FIG. 2;

FIG. 5 is a cross-sectional view of the valve system and a portion of the container of FIG. 1 taken along line 55 of FIG. 2;

FIG. 6 is a cross-sectional view of the valve system and container of FIG. 5 when the valve system is being dispensed;

FIG. 7 is a cross-sectional view of the valve system and container of FIG. 5 when the valve system is being filled;

FIG. 8 is a cross-sectional view of a portion of the container of FIG. 1 taken along line 4-4 of FIG. 2 with an alternative embodiment of the valve system of the present invention;

FIG. 9 is a cross-sectional view of the valve system and container of FIG. 8 when the valve system is being dispensed;

FIG. 10 is a cross-sectional view of the valve system and container of FIG. 8 when the valve system is being filled; and

FIG. 11 is a schematic diagram of the container and valve system of FIG. 1 with an applicator.

### DESCRIPTION OF THE INVENTION

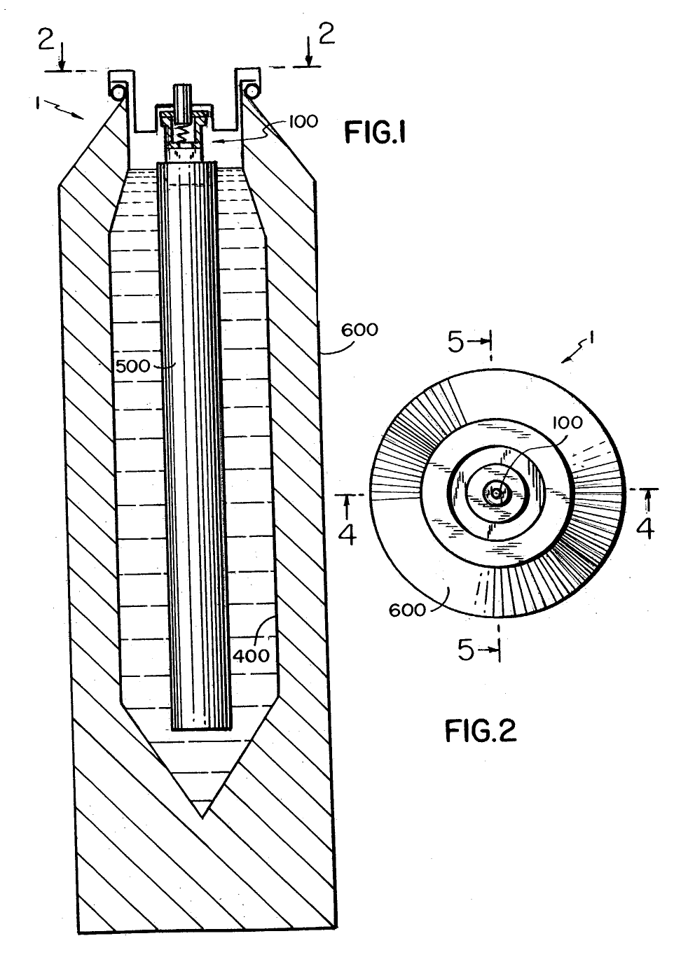

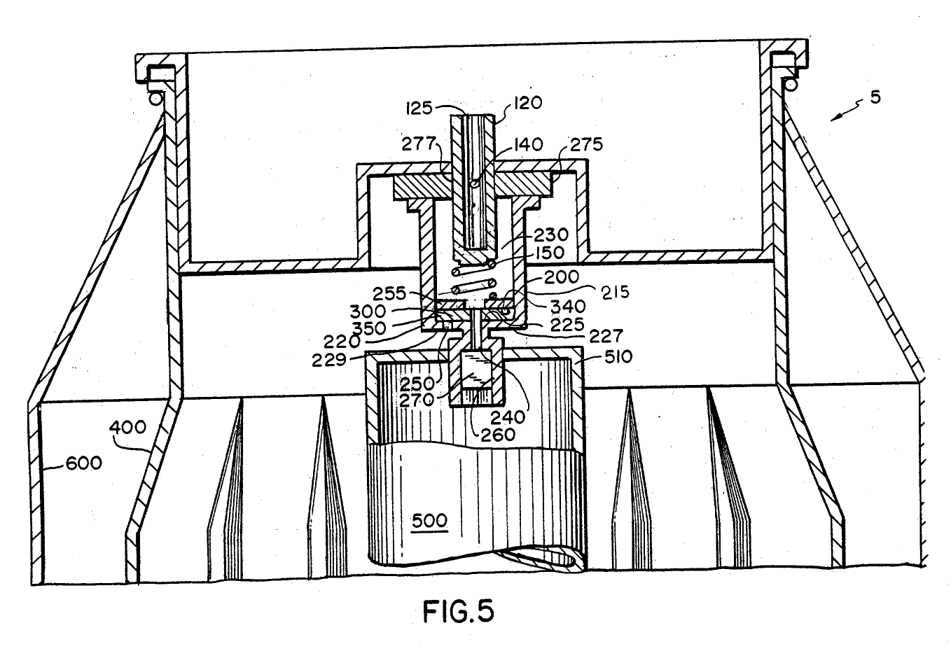

Referring to FIGS. 1 through 5, there is shown a preferred embodiment of the container and the valve system of the present invention generally represented by reference numerals 1 and 100, respectively. Valve system 100 has a stem 120, a spring 150, a valve housing 200, a flange 260, an upper gasket 275 and a one-way valve 300. Container 1 has a first source or first inner chamber 400, a second source or second inner chamber 500 and an outer canister 600.

In this embodiment, valve system 100 preferably allows one-way flow from first chamber 400 and two-way flow with second chamber 500. Valve system 100 also allows second chamber 500 to be filled after insertion into first chamber 400 and sealing engagement with valve system 100. However, alternative embodiments can include one-way flow from second chamber 500 and two-way flow with first chamber 400. Also, where more than two substances in more than two separate chambers are to be ejected, valve system 100 can have any combination of one-way flow and two-way flow that allows mixing of the substances within valve housing 200 and then ejection to the atmosphere. First chamber 400 can have a two-way valve while the number of one-way valves can be determined by the number of second or inner chambers 500.

An example of first chamber 400 is disclosed in the co-pending and commonly owned U.S. Application entitled “Container” which has been filed evenly herewith (Attorney Docket No. G-00288), and the disclosure of which is incorporated herein by reference.

Valve system 100, first chamber 400 and second chamber 500 are sealingly engaged with outer canister 600. Preferably, the sealing engagement is at a top portion 5 of container 1. Stem 120 is preferably cylindrical in shape and extends into valve housing 200. Preferably, stem 120 extends into valve housing 200 along the longitudinal axis of the valve housing and is an actuator for valve system 100 which will be discussed later in detail.

Stem 120 has a stem channel 125, an upper end 130, a lower end 135, and an ejection orifice 140. Upper end 130 is open to atmosphere. Lower end 135 is a closed end and has an engaging abutment 145. Stem channel 125 preferably extends concentrically through stem 120 and is open to atmosphere at upper end 130 and closed at lower end 135. Engaging abutment 145 extends downward from the bottom of lower end 135 and is adapted to fittingly engage spring 150. Ejection orifice 140 is located along stem 120, preferably above valve housing 200, and extends from stem channel 125 to an outer surface 175 of stem 120.

Valve housing 200 is substantially cylindrical in shape. Valve housing 200 has an open upper end 205 having an upper surface 210, and a lower end 215 having a bottom 220 with a bottom inner surface 225 and a bottom outer surface 227. Valve housing 200 has a hollow cavity or core defining an inner volume or mixing chamber 230. Preferably mixing chamber is also substantially cylindrical in shape. Although in this embodiment mixing chamber 230 is substantially cylindrical in shape, the mixing chamber can include mixing structures (not shown) extending from the inner surface thereof, such as, for example, ribs or fins, to facilitate mixing of the substances that enter the mixing chamber, as will be discussed later in detail. Upper end 205 of valve housing 200 is preferably flared outwardly. Mixing chamber 230 has a volume that is large enough to house spring 150 and lower end 135 of stem 120. Valve housing 200 also has a flange orifice 240 and a chamber orifice 250 disposed on lower end 215 of the valve housing.

Bottom inner surface 225 of valve housing 200 has projections 255 extending therefrom. Preferably, projections 255 are perpendicular to bottom inner surface 225. Spring 150 extends downwardly from stem 20 and abuts against projections 255, which act as a seat for the spring. Preferably, there are four projections 255. Alternatively, spring 150 can abut against bottom inner surface 225 of valve housing 200. Spring 150 upwardly biases stem 120 away from bottom 220 of valve housing 200.

Flange 260 has a substantially rectangular or diamond-like shape with a lower end 262, an upper end 264 and a flange channel 270. Flange 260 is transversely connected to valve housing 200 with flange upper end 264 being sealingly engaged with bottom outer surface 227 of the valve housing. Due to the rectangular or diamond-like shape of flange 260 and the transverse positioning of the flange with respect to bottom outer surface 227 of valve housing 200, periphery surface 229 of bottom outer surface 227 is adjacent to the flange on opposing sides, i.e., portions of bottom outer surface 227 are not connected to, and covered by, upper end 264 of the flange. Thus, periphery surface 229 is in fluid communication with first chamber 400.

Flange lower end 262 is sealingly engaged with, and through, an upper end 510 of second chamber 500. Flange channel 270 extends through flange 260 from lower end 262 to upper end 264. Preferably, flange channel 270 runs parallel to the longitudinal axis of second chamber 500 and through flange lower end 262 and flange upper end 264 such that flange 260 is open at its top and bottom. More preferably, flange channel 270 is concentrically aligned with flange 260.

Flange orifice 240 provides for second chamber 500 to be in fluid communication with mixing chamber 230 of valve housing 200 through flange channel 270. Preferably, flange orifice 240 is centrally located along bottom 220 of valve housing 200. More preferably, flange orifice 240 is concentrically aligned with flange channel 270. Flange orifice 240 is preferably an opening, which allows for two-way flow but can also be a two-way valve. One-way valve 300 has a central hole 301 such that flange orifice 240 is disposed through the one-way valve and valve housing 200.

Chamber orifice 250 is preferably located on lower end 215 of valve housing 200. More preferably, chamber orifice 250 is located on bottom 220 of valve housing 200 through periphery surface 229 of bottom outer surface 227, i.e., adjacent to flange 260 such that chamber orifice 250 is in fluid communication with first chamber 400.

One-way valve 300 is aligned with chamber orifice 250 to selectively allow flow from first chamber 400 into mixing chamber 230 of valve housing 200. Preferably, one-way valve 300 is a gasket positioned along bottom inner surface 225 of valve housing 200. More preferably, one-way valve 300 is a disk-like gasket having the same or similar diameter as the diameter of bottom inner surface 225.

One-way valve 300 has a top surface 310, channels 320 and a hinge groove 340. Channels 320 are formed through one-way valve 300 and correspond to, and mate with, projections 255 of valve housing 200 so that one-way valve 300 can sit flush with bottom inner surface 225 of the valve housing. Hinge groove 340 is formed partially through one-way valve 300 along top surface 310 of the valve. Hinge groove 340 is preferably disposed between, and perpendicular to, channels 320.

Channels 320 and hinge groove 340 form a flap 350 in one-way valve 300. Hinge groove 340 provides more flexibility to one-way valve 300 and facilitates the pivotal movement or bending along the hinge groove of the portion of the valve between channels 320, i.e., flap 350. This allows flap 350 to move away from bottom inner surface 225 of valve housing 200 to provide for flow from first chamber 400 through chamber orifice 250 into mixing chamber 230 when valve system 100 is actuated.

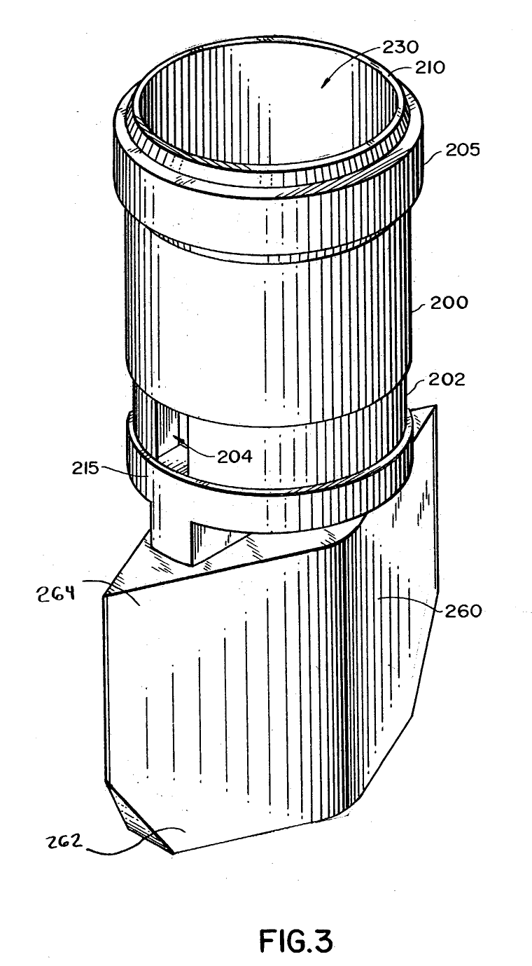

Preferably, one-way valve 300 is co-injected or double-shot molded with valve housing 200. To facilitate the co-injection process, valve housing 200 can have a circumferential channel or recess 202 formed on the outer surface of lower end 215 and openings 204 formed through the channel or recess into the mixing chamber (only one of which is shown in FIG. 3). When co-injected against bottom inner surface 225 of valve housing 200, one-way valve or gasket 300 flows through openings 204 into channel 202. However, alternative methods can be used in making valve housing 200 and one-way valve 300 including separate molding processes and assembly of the housing and valve.

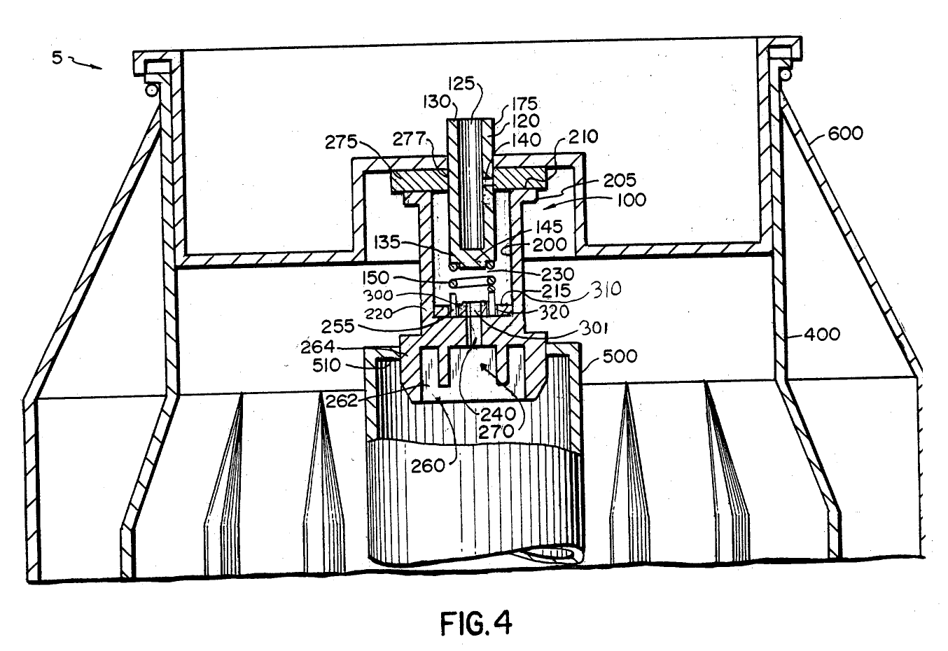

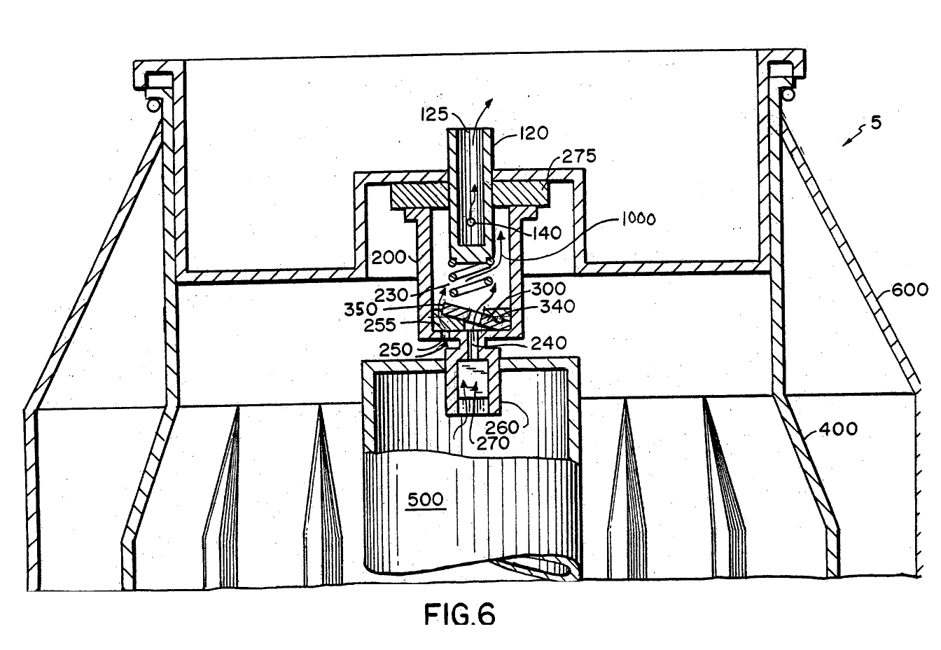

Referring to FIGS. 4 through 6, flap 350 of one-way valve 300 removably engages bottom inner surface 225 of valve housing 200. A higher pressure in first chamber 400 than in mixing chamber 230 causes a separation between flap 350 and bottom inner surface 225 of valve housing 200. This separation or pivotal movement of flap 350 is facilitated by hinge groove 340. The separation allows flow of the contents in first chamber 400 through chamber orifice 250 and under flap 350 into mixing chamber 230. However, when the pressure in first chamber 400 and mixing chamber 230 are equalized or when the pressure is greater in the mixing chamber, one-way valve 300 reseats, sealingly engaging with bottom inner surface 225 and thus sealingly engages chamber orifice 250.

In this embodiment, the positioning of chamber orifice 250 adjacent to flange 260 along bottom 220 provides for one-way flow from first chamber 400 into mixing chamber 230. However, chamber orifice 250 can be alternatively positioned in other locations along valve housing 200 to allow one-way flow from first chamber 400 into mixing chamber 230. Also, an alternative number of chamber orifices 250 can be used to allow one-way flow from first chamber 400 into mixing chamber 230. Additionally, while the preferred embodiment has one one-way valve 300 aligned with one chamber orifice 250, alternative embodiments can include two or more one-way valves 300 aligned with two or more chamber orifices 250, such as, for example, when there are more than two chambers that are dispensing substances to be mixed and then ejected.

In this embodiment, one-way valve 300 is preferably a gasket that is co-injected with valve housing 200 along bottom inner surface 225 of the valve housing. Alternatively, one-way valve 300 can be another type of valve such that the contents of first chamber 400 is selectively in fluid communication with mixing chamber 230.

Upper gasket 275 sealingly engages with upper surface 210 of valve housing 200. Preferably, flared out upper end 205 of valve housing 200 acts as a seat for upper gasket 275. Upper gasket 275 is preferably circular in shape having a center hole 277 with a diameter such that stem 120 can sealingly slide therethrough. Preferably, center hole 277 is concentrically located in upper gasket 275. When stem 120 is in its upwardly biased position, upper gasket 275 sealingly surrounds stem 120 such that ejection orifice 140 is completely sealed. However, when stem 120 is downwardly depressed against the bias of spring 150 toward bottom 220 of valve housing 200, ejection orifice 140 slides below upper gasket 275 and into mixing chamber 230. This downward movement of stem 120 and ejection orifice 140 provides for fluid communication between stem channel 125 and mixing chamber 230.

In this embodiment, actuation and ejection is accomplished through a sliding side valve mechanism, i.e., ejection orifice 140 and upper gasket 275. Alternatively, other mechanisms could be utilized, such as, for example, a sliding mechanism with a base orifice and gasket that selectively seals the base orifice.

In operation, this embodiment of valve system 100 works as follows. The direction of flow is generally represented by the series of arrows 1000. By way of example, the embodiment can be used to eject a product that requires the mixing of two substances. In particular, this embodiment can be used to eject a hair dye product that requires two substances, i.e., a developer composition (“developer”) and a dye composition (“dye”), to be mixed, then ejected.

Preferably, the developer is contained in first chamber 400, while the dye is contained in second chamber 500. A user actuates valve system 100 by pressing stem 120 downward against the bias of spring 150. This causes stem 120 to slide through upper gasket 275, causing ejection orifice 140 to move into fluid communication with mixing chamber 230 of valve housing 200. Since stem channel 125 is in fluid communication with the atmosphere at upper end 130 and in fluid communication with ejection orifice 140, there is a decrease in pressure in mixing chamber 230 of valve housing 200. The pressure differential between second chamber 500 (at a higher pressure) and mixing chamber 230 (at the lower pressure of atmosphere) causes the dye to flow from second chamber 500 into mixing chamber 230, through flange channel 270 and flange orifice 240.

Likewise, the pressure differential between first chamber 400 (at a higher pressure) and mixing chamber 230 (at the lower pressure of atmosphere) causes one-way valve 300 to open and the developer to flow from first chamber 400 into mixing chamber 230, through chamber orifice 250 under flap 350 of one-way valve 300. The developer and the dye are then mixed together in mixing chamber 230 of valve housing 200 and ejected through ejection orifice 140, through stem channel 125, and out to the atmosphere.

When the user stops pressing downward on stem 120, the bias of spring 150 causes stem 120 to slide upwardly through upper gasket 275 and ejection orifice 140 is then sealed by the upper gasket. This causes the pressure in mixing chamber 230 and the inner chambers, i.e., first chamber 400 and second chamber 500, to equilibrate as a result of the fluid communication between second chamber 500 and mixing chamber 230 through flange channel 270 and flange orifice 240.

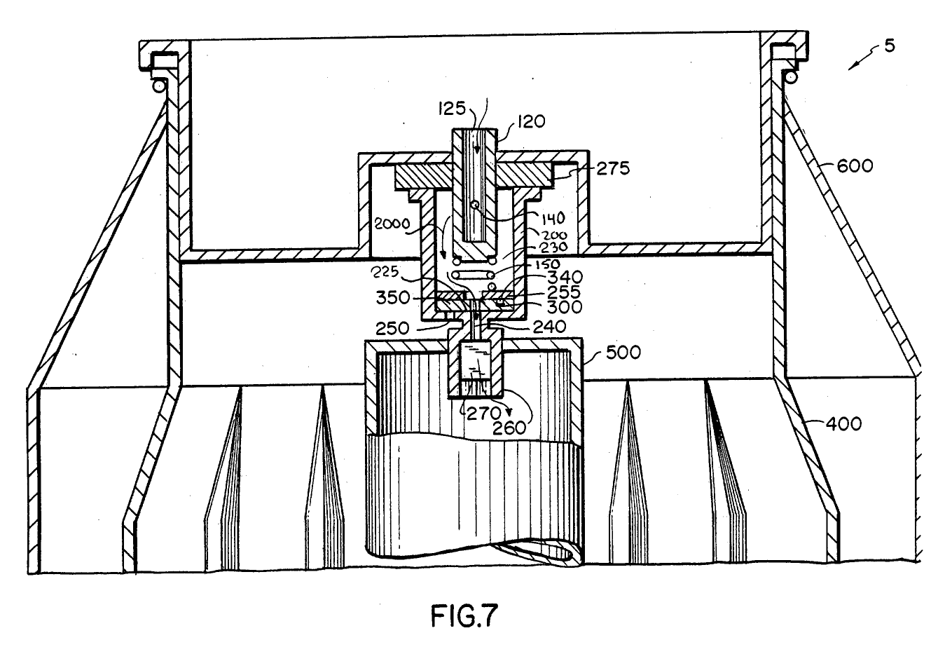

Referring to FIG. 7, one-way valve 300 allows the filling of second chamber 500 through valve system 100. The direction of flow is generally represented by the series of arrows 2000. By way of example, dye can be filled into second chamber 500 through valve system 100. When stem 120 is pressed down and dye is introduced into mixing chamber 230 of valve housing 200 through stem channel 125, under a pressure higher than the pressure in first chamber 400 and second chamber 500, one-way valve 300 sealingly engages with the bottom inner surface 225 of the valve housing. Thus, first chamber 400 is no longer in fluid communication with mixing chamber 230 during the filling process. The dye then flows from mixing chamber 230 into second chamber 500 through flange orifice 240 and flange channel 270.

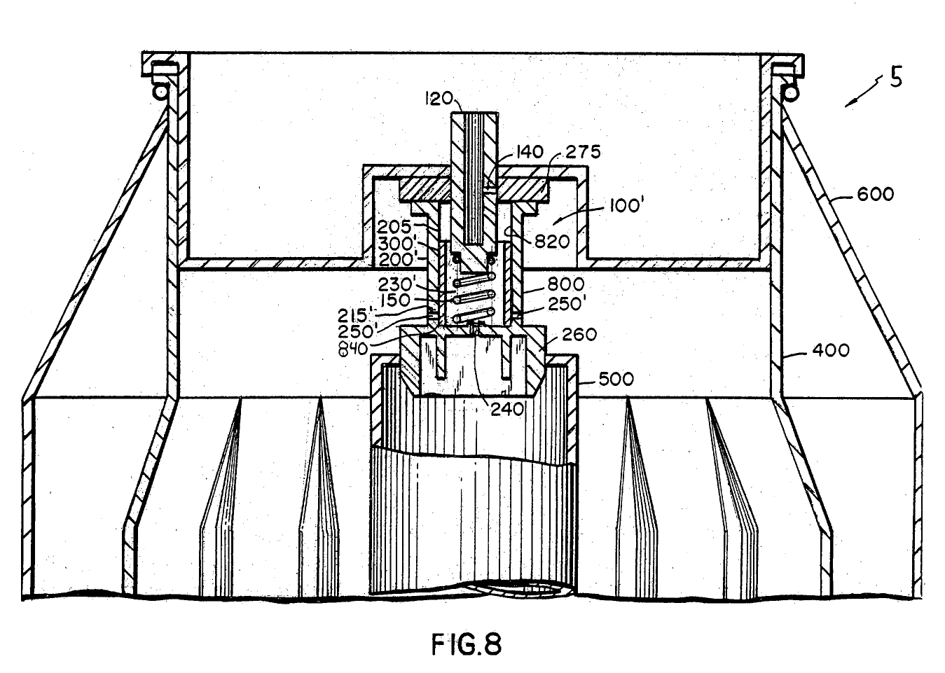

Referring to FIGS. 8 through 10, there is shown a second embodiment of the valve system of the present invention generally represented by reference numeral 100′. Features of valve system 100′ that are the same or similar to the features of the preferred embodiment of FIGS. 1 through 7, are represented by the same reference numerals from valve system 100. Valve system 100′ has a stem 120 with an ejection orifice 140, a spring 150, a valve housing 200′, a flange 260 and an upper gasket 275. Container 1 has a first chamber 400, a second chamber 500 and an outer canister 600.

Valve housing 200′ has an upper end 205, a lower end 215′ and a circumferential sidewall 800 therebetween. Valve housing 200′ and circumferential sidewall 800 define a substantially cylindrical mixing chamber 230′. Sidewall 800 has an inner surface 820 and chamber orifices 250′ formed therethrough. Preferably, there are two chamber orifices 250′. More preferably, chamber orifices 250′ are diametrically opposed along sidewall 800. Even more preferably, chamber orifices 250′ are disposed along sidewall 800 in proximity to lower end 215′ of valve housing 200′.

Valve housing 200′ has a one-way valve 300′. One-way valve 300′ is a cylindrical gasket having a bottom portion 840. One-way valve 300′ has an outer diameter that is slightly smaller than the inner diameter of circumferential sidewall 800. One-way valve 300′ is disposed along inner surface 820 such that the valve is aligned with and sealingly covers chamber orifices 250′.

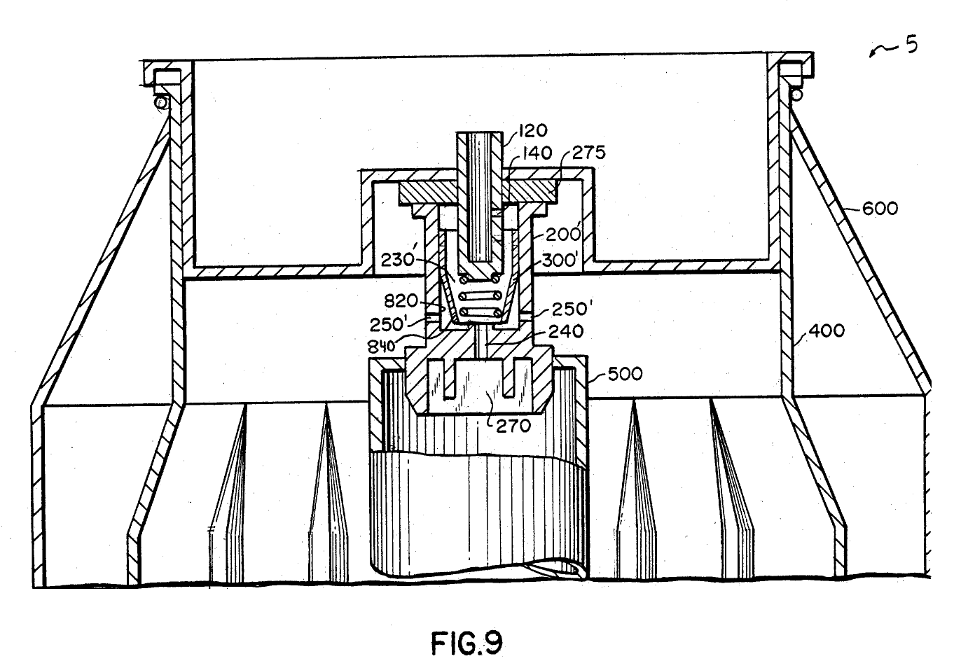

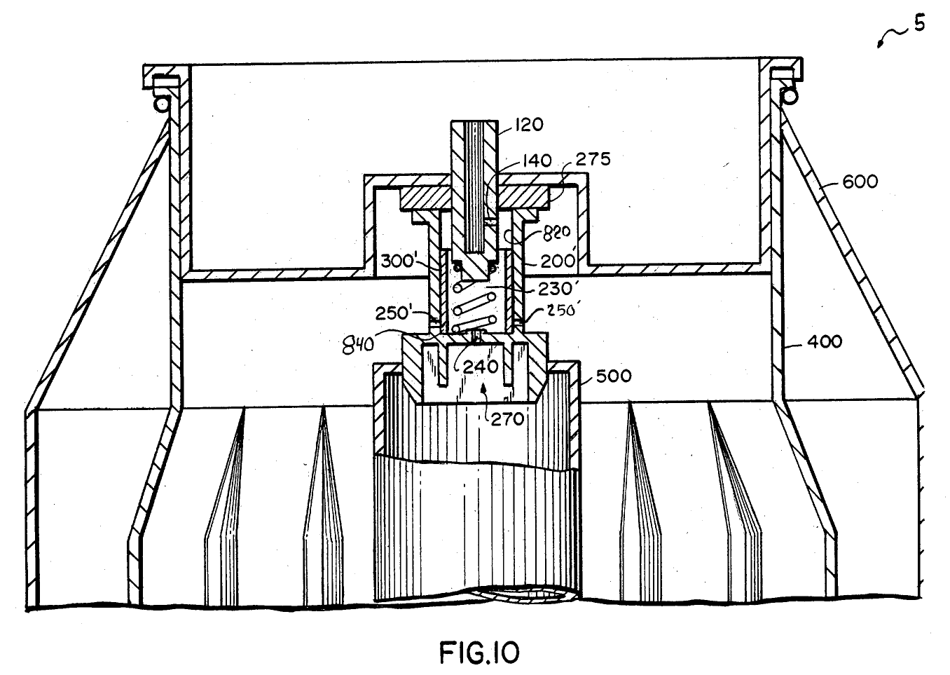

In use, a pressure higher in first chamber 400 than in mixing chamber 230′ causes bottom portion 840 of one-way valve 300′ to separate from inner surface 820 of sidewall 800, as shown in FIG. 9. This separation allows flow of the contents of first chamber 400 through chamber orifices 250′, under bottom portion 840 and into mixing chamber 230′. However, when the pressure in first chamber 400 and mixing chamber 230′ are equalized or when the pressure is greater in the mixing chamber, bottom portion 840 of one-way valve 300′ reseats, sealingly engaging with inner surface 820 and thus sealingly engages chamber orifices 250′. While this embodiment uses two chamber orifices 250′, any number or positioning of the chamber orifices can be used.

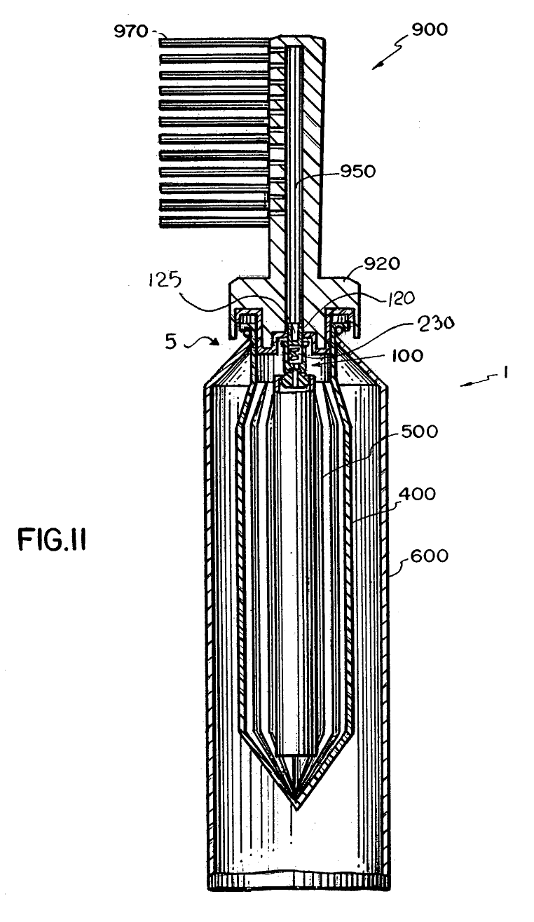

As shown in FIG. 10, one-way valve 300′ also allows filling of second chamber 500 through valve system 100′. When the pressure in mixing chamber 230′ is higher than the pressure in first chamber 400, bottom portion 840 of one-way valve 300′ reseats, sealingly engaging with inner surface 820 and thus sealingly engages chamber orifices 250′. This allows a substance to be filled into second chamber 500 while first chamber 400 is no longer in fluid communication with mixing chamber 230′.

Referring again to FIGS. 1 through 7, pressurization of first chamber 400 and second chamber 500 is provided by a propellant. Preferably, the propellant is contained within outer canister 600 surrounding first chamber 400, and applying pressure on the first chamber. First chamber 400, in turn, applies pressure on second chamber 500 that is preferably housed concentrically within the first chamber. Preferably, the propellant is a liquefied hydrocarbon or compressed gas. The bottom of container 1 preferably facilitates pressurization of outer canister 600 with the propellant. In this embodiment, the bottom of outer canister 600 is grommetted. However, outer canister 600 may be adapted with alternative means for pressurization of the outer canister with a propellant, including under the cup pressurization.

An example of container 1 is disclosed in the co-pending and commonly owned U.S. Application entitled “Pressurized Container” which has been filed evenly herewith (Attorney Docket No. G-00281), and the disclosure of which is incorporated herein by reference.

Valve system 100 uses the pressure differential between the atmosphere and first and second chambers 400, 500 to cause the flow of the developer and dye into mixing chamber 230 of valve housing 200. Thus, the orientation of valve system 100 does not affect the ejection of the mixed product.

In this embodiment, which is by way of example, valve system 100 utilizes a two-way valve in combination with a one-way valve to selectively allow two substances from two separate chambers to flow into mixing chamber 230 of valve housing 200 for mixing and ejection. However, valve system 100 could also have other combinations of one-way valves and a two-way valve to selectively allow flow of any number of substances from their corresponding separate chambers into mixing chamber 230 of valve housing 200 where the substances are mixed and then ejected into the atmosphere.

While this embodiment has second chamber 500 disposed in first chamber 400, alternative positioning of the chambers can also be used that provides for pressurization of the chambers, such as, for example, having first and second chambers 400, 500 adjacent to each other and disposed in outer canister 600. In such an alternative embodiment, valve system 100 could have a one-way valve and a two-way valve operably connected to the chambers to selectively allow flow of the substances from the chambers into mixing chamber 230 of valve housing 200 where the substances would mix and then be ejected into the atmosphere.

The present invention allows the mixing and dispensing of a plurality of substances that are stored separately. Additionally, the present invention does not require mixing of the propellant with any of the stored substances.

Referring to FIG. 11, an applicator of the present invention is shown and generally represented by reference numeral 900. Applicator 900 has a base 920, an applicator channel 950 and applicator members 970.

Applicator 900 is attached to top portion 5 of container 1 at base 920. Preferably applicator 900 is removably attached to container 1. Applicator 900 is secured to stem 120 of valve system 100 such that movement of the applicator causes actuation of the valve system. Applicator channel 950 is in fluid communication with stem channel 125 of stem 120 to provide for flow out of mixing chamber 230. Applicator members 970 are tine-like structures that form a comb for application of the dispensed product. While applicator 900 is a comb-like device that is in fluid communication with valve system 100, alternative applicator devices can also be used with container 1 and valve system 100 that allow for application of the product after the different substances have been mixed and ejected from mixing chamber 230.

The present invention having been thus described with particular reference to the preferred forms thereof, it will be obvious that various changes and modifications may be made therein without departing from the spirit and scope of the present invention as defined in the appended claims.

What is claimed is:

1. A valve system adapted for mixing and ejecting into the atmosphere two or more substances separately stored under pressure, the valve system comprising:
a first source for containing a first substance;
a second source for containing a second substance, said second source in fluid isolation from said first source;
an actuator;
a mixing chamber in communication with said actuator; and
a valve operatively connected to said actuator, wherein said valve allows fluid communication between said second source and said mixing chamber, selective fluid communication between said mixing chamber and said first source, and selective fluid communication between said mixing chamber and the atmosphere, and wherein actuation of said actuator (i) allows said first substance and said second substance to flow into said mixing chamber, mix in said mixing chamber and be ejected from said mixing chamber to the atmosphere, or (ii) allows said second substance to be filled into said second source.

2. The valve system of claim 1, wherein said valve comprises a first orifice and a first gasket, said first orifice selectively sealed by said first gasket.

3. The valve system of claim 2, wherein actuation of said actuator allows said first orifice and said first gasket to unseal causing said first substance to flow into said mixing chamber or allows said first orifice and said first gasket to remain sealed when said second substance is filled into said second source.

4. The valve system of claim 2, wherein said first orifice is positioned along a bottom portion of said mixing chamber.

5. The valve system of claim 2, wherein said first orifice is two orifices.

6. The valve system of claim 2, wherein said valve further comprises a second orifice and a second gasket, said second orifice selectively sealed by said second gasket, wherein said actuator causes said second orifice and said second gasket to unseal when actuated.

7. The valve system of claim 6, wherein said actuator is a slidable stem having a side, and wherein said stem is biased in a non-actuated position.

8. The valve system of claim 7, wherein said second orifice is positioned along said side, said second gasket surrounds at least a portion of said stem, and actuation of said actuator causes said stem to slide below said second gasket.

9. The valve system of claim 1, wherein said mixing chamber is substantially cylindrical.

10. The valve system of claim 1, wherein said valve is co-injection molded with said mixing chamber.

11. A container adapted for mixing and ejecting into the atmosphere two or more substances separately stored under pressure, the container comprising:
a propellant chamber having a propellant;
a first chamber isolated from said propellant chamber and having a first substance;
a second chamber isolated from said propellant chamber and said first chamber, and having a second substance; and
a valve system comprising:
an actuator;
a mixing chamber in communication with said actuator;
a valve operatively connected to said actuator, said valve in selective fluid communication with said mixing chamber and said first chamber, and in selective fluid communication with atmosphere, and said mixing chamber and said second chamber, wherein actuation of said actuator (i) allows said first substance and said second substance to flow into said mixing chamber, mix in said mixing chamber and be ejected from said mixing chamber to the atmosphere or (ii) allows said second substance to be filled into said second chamber.

12. The container of claim 11, wherein said propellant pressurizes said first and second chambers.

13. The container of claim 12, wherein said valve comprises a first orifice and a first gasket, and wherein said first orifice is selectively sealed by said first gasket.

14. The container of claim 13, wherein actuation of said actuator allows said first orifice and said first gasket to unseal causing said first substance to flow into said mixing chamber or allows said first orifice and said first gasket to remain sealed when said second substance is filled into said second chamber.

15. The container of claim 13, wherein said first orifice is positioned along a bottom portion of said mixing chamber.

16. The container of claim 13, wherein said first orifice is two orifices.

17. The container of claim 13, wherein said valve comprises a second orifice and a second gasket, said second orifice selectively sealed by said second gasket, and said actuator causes said second orifice and said second gasket to unseal when actuated.

18. The container of claim 17, wherein said actuator is a slidable stem having a side, and wherein said stem is biased in a non-actuated position.

19. The container of claim 18, wherein said second orifice is positioned along said side, said second gasket surrounds said stem, and actuation of said actuator causes said stem to slide below said second gasket.

20. The container of claim 11, wherein said valve is co-injected molded with said mixing chamber.

21. The container of claim 11, wherein said mixing chamber is substantially cylindrical.
